(19) United States
(12) Patent Application Publication
(10) Pub. No.: US 2022/0049082 A1
(43) Pub. Date: Feb. 17, 2022

(54) RESIN COMPOSITION AND MOLDED BODY THEREOF

(71) Applicant: KURARAY CO., LTD., Kurashiki-shi (JP)

(72) Inventors: Yusuke AMANO, Okayama (JP); Eiichi ISHIDA, Okayama (JP); Masayoshi YAMANAKA, Okayama (JP); Kazuhiko MAEKAWA, Okayama (JP)

(73) Assignee: KURARAYCO., LTD., Kurashiki-shi (JP)

(21) Appl. No.: 17/275,345

(22) PCT Filed: Sep. 12, 2019
(86) PCT No.: PCT/JP2019/035969

§ 371 Date: Mar. 11, 2021

(30) Foreign Application Priority Data
Sep. 12, 2018 (JP) 2018-170759

(51) Int. Cl. C08L 51/06; C08L 29/06; C08J 5/18

(52) U.S. Cl. CPC C08L 51/06; C08L 29/06; C08J 5/18; C08J 2429/06; C08J 2351/06; C08J 2451/06; C08J 2329/06; C08L 2203/16

(57) ABSTRACT

The present invention provides a resin composition having superior flexibility and that exhibits excellent durability in thermal molding, and a molded body of such a resin composition. The present invention relates to a resin composition comprising: a copolymer (B) constituted of a vinyl alcohol polymer (B-1) region and a diene polymer (B-2) region; and at least one compound selected from the group consisting of a phenol-based compound (C), an amine-based compound (D), and a phosphorus-based compound (E).

### TECHNICAL FIELD

The present invention relates to a resin composition having superior flexibility and that exhibits excellent durability in thermal molding, and to a molded body thereof.

### BACKGROUND ART

A vinyl alcohol resin has excellent coating properties (e.g., mechanical strength, oil resistance, film formability, oxygen gas barrier properties) owning to its high crystallinity and hydrophilicity, and has been used in a wide range of applications by taking advantage of these properties, for example, such as in emulsifiers, suspending agents, surfactants, textile finishing agents, various binders, paper processing agents, adhesives, and various packaging materials, sheets, and containers. However, a vinyl alcohol resin usually has a glass transition point higher than ordinary temperature, and the high crystallinity owning to this property poses drawbacks such as poor flexibility and weak flex resistance, and low reactivity, which can lead to serious problems depending on use. It is possible to overcome the low flexibility with the combined use of a plasticizer. However, this inevitably results in decrease of other properties such as mechanical and barrier properties as a result of a bleed out of the plasticizer, or serious impairment of crystallinity.

A method is proposed that chemically introduces a specific structure into a vinyl alcohol resin in the form of a graft chain. Patent Literature 1 describes an example of a polymer in which a synthetic rubber having incorporated therein a modified functional group introduced to its terminal is introduced as a graft chain via a reactive group through the reaction of the synthetic rubber in a dimethyl sulfoxide solution of vinyl alcohol resin.

Patent Literature 2 and Patent Literature 3 disclose methods for producing a graft copolymer by contacting a vinyl alcohol resin with butadiene after generating radicals on the vinyl alcohol resin with the use of ionizing radiation.

### CITATION LIST

### Patent Literature

Patent Literature 1: WO 2015/190029 A1

Patent Literature 2: JP 39(1964)-6386 B1

Patent Literature 3: JP 41(1966)-21994 B1

### SUMMARY OF INVENTION

### Technical Problem

However, these related art documents do not give consideration to the heat stability of a graft copolymer. In reality, a graft copolymer has poor heat stability, and very easily deteriorates under molding conditions requiring high temperature. That is, a graft copolymer involves processability issues in actual practice.

The present invention has been made to provide a solution to the foregoing problems, and it is an object of the present invention to provide a resin composition having superior flexibility and that exhibits excellent durability in thermal molding. Another object of the present invention is to provide a molded body of such a resin composition.

### Solution to Problem

The present inventors conducted intensive studies to find a solution to the foregoing problems, and found that the poor heat stability of a copolymer (for example, a graft copolymer) stems from the reaction between the carbonyl group generated by oxidation reaction of a diene polymer region and the hydroxyl group of a vinyl alcohol polymer region, and that the foregoing problems can be solved by preventing the causal oxidation reaction of the diene polymer region with the use of a resin composition containing specific compounds. The present invention was completed on the basis of these findings.

Specifically, the present invention includes the following.

[1] A resin composition comprising: a copolymer (B) constituted of a vinyl alcohol polymer (B-1) region and a diene polymer (B-2) region; and
at least one compound selected from the group consisting of a phenol-based compound (C), an amine-based compound (D), and a phosphorus-based compound (E).
[2] The resin composition of [1], wherein the copolymer (B) is a graft copolymer (B1).
[3] The resin composition of [1] or [2], wherein the phenol-based compound (C), the amine-based compound (D), or the phosphorus-based compound (E) has a molecular weight of 100 or more and 2,000 or less.
[4] The resin composition of any one of [1] to [3], wherein the resin composition comprises 0.05 to 15 parts by mass of at least one compound selected from the group consisting of the phenol-based compound (C), the amine-based compound (D), and the phosphorus-based compound (E) per 100 parts by mass of the resin composition.
[5] The resin composition of any one of [1] to [4], wherein the resin composition further comprises a vinyl alcohol polymer (A).
[6] The resin composition of any one of [1] to [5], wherein the phenol-based compound (C) is a compound represented by the following general formula [I] or [II],

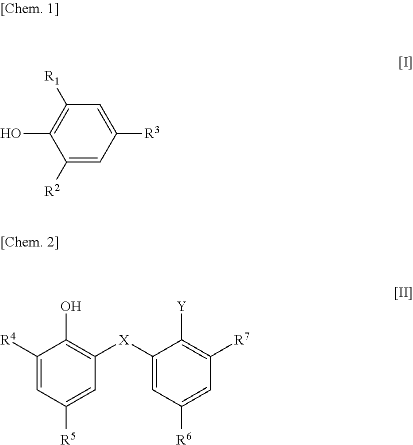

wherein R¹ to R⁷ each independently represent a hydrocarbon group having 1 to 15 carbon atoms, X represents a divalent hydrocarbon group having 1 to 15 carbon atoms, and Y represents a vinyloxy group or a (meth)acryloyloxy group, where the hydrocarbon groups represented by R¹ to R⁷ and X may contain at least one kind of group selected from the group consisting of —O—, —S—, —NH—, —N(R⁸)—, —O(CO)—, and —CO—, where R⁸ represents a hydrocarbon group having 1 to 6 carbon atoms.
[7] The resin composition of [6], wherein the phenol-based compound (C) is a compound represented by general formula [I], where R′, R², and R³ are hydrocarbon groups having 1 to 6 carbon atoms.
[8] The resin composition of [6], wherein the phenol-based compound (C) is a compound represented by general formula [II], where R⁴, R⁵, R⁶, and R⁷ are hydrocarbon groups having 1 to 6 carbon atoms, X is a divalent hydrocarbon group having 1 to 6 carbon atoms, and Y is an acryloyloxy group.
[9] The resin composition of any one of [1] to [6], wherein the phenol-based compound (C) is at least one selected from the group consisting of dibutylhydroxytoluene and 2-[1-(2-hydroxy-3,5-di-t-pentylphenyl)ethyl]-4,6-di-t-pentylphenyl acrylate.
[10] The resin composition of any one of [1] to [5], wherein the amine-based compound (D) is an amine having an aromatic group.
[11] The resin composition of [10], wherein the amine having an aromatic group is a secondary amine having two or more aromatic rings, or a tertiary amine having two or more aromatic rings.
[12] The resin composition of [11], wherein the secondary amine having two or more aromatic rings is a compound represented by the following general formula [IV],

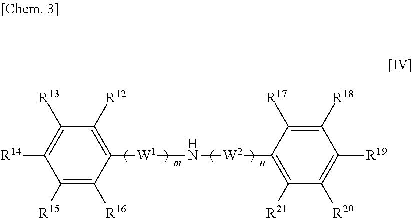

wherein R¹² to R²¹ each independently represent a hydrogen atom or a hydrocarbon group having 1 to 15 carbon atoms, W¹ and W² represent divalent hydrocarbon groups having 1 to 15 carbon atoms, and m and n are each independently 0 or 1, where the hydrocarbon groups represented by R¹² to R²¹ and W¹ and W² may contain at least one kind of group selected from the group consisting of —O—, —S—, —NH—, —N(R²²)—, —O(CO)—, and —CO—, and wherein R¹² to R²¹ may together form a ring, and R²² represents a hydrocarbon group having 1 to 6 carbon atoms.
[13] The resin composition of [11], wherein the secondary amine having two or more aromatic rings is an amine having a diarylamine skeleton.
[14] The resin composition of [13], wherein the amine having a diarylamine skeleton is at least one selected from the group consisting of 4,4′-bis(α, α-dimethylbenzyl)diphenylamine, N-phenyl-N′-isopropyl-p-phenylenediamine, N-phenyl-N′-(1,3-dimethylbutyl)-p-phenylenediamine, 2,3:5,6-dibenzo-1,4-thiazine, and N,N,N′N′-tetramethyl-p-diaminodiphenylmethane.
[15] The resin composition of any one of [1] to [5], wherein the phosphorus-based compound (E) is a trivalent phosphite ester.
[16] The resin composition of any one of [1] to [15], wherein the resin composition comprises at least one compound selected from the group consisting of the phenol-based compound (C) and the amine-based compound (D); and the phosphorus-based compound (E).
[17] The resin composition of [16], wherein the resin composition has a mass ratio (W_{CD}/W_{E}) of 90/10 to 50/50, where W_{CD} is a mass of at least one compound selected from the group consisting of the phenol-based compound (C) and the amine-based compound (D), and W_{E} is a mass of the phosphorus-based compound (E).
[18] The resin composition of [16], wherein the resin composition comprises the amine-based compound (D) and the phosphorus-based compound (E).
[19] A film comprising the resin composition of any one of [1] to [18].

### Advantageous Effects of Invention

The present invention can provide a resin composition having superior flexibility and that exhibits excellent durability in thermal molding. The present invention can also provide a molded body of such a resin composition.

### BRIEF DESCRIPTION OF DRAWINGS

FIG. 1 is a FT-IR chart of a resin composition obtained in Synthesis Example 1.

FIG. 2 is a FT-IR chart of a film molded by pressing the compound of Example 1 using the method described below.

FIG. 3 is a FT-IR chart of a film molded by pressing the compound of Comparative Example 2 using the method described below.

### DESCRIPTION OF EMBODIMENTS

A resin composition of the present invention comprises: a copolymer (B) constituted of a vinyl alcohol polymer (B-1) region and a diene polymer (B-2) region; and at least one compound selected from the group consisting of a phenol-based compound (C), an amine-based compound (D), and a phosphorus-based compound (E).

Copolymer (B)

The copolymer (B) is constituted of a vinyl alcohol polymer (B-1) region and a diene polymer (B-2) region. The copolymer (B) is not particularly limited, as long as it is a copolymer having at least one vinyl alcohol polymer (B-1) region, and at least one diene polymer (B-2) region. The copolymer (B) is, for example, a graft copolymer (B1) or a block copolymer (B2).

Graft Copolymer (B1)

The copolymer (B) is preferably a graft copolymer (B1). The structure of the graft copolymer (B1) is not particularly limited. It is, however, preferable that the graft copolymer (B1) be constituted of a main chain formed by a vinyl alcohol polymer (B-1) region, and a side chain formed by a diene polymer (B-2) region. That is, the graft copolymer (B1) is preferably one in which a side chain formed by a diene polymer (B-2) region is introduced into a main chain formed by a vinyl alcohol polymer (B-1) region. Particularly preferably, the graft copolymer (B1) is one in which a plurality of diene polymer (B-2) regions is attached to a single vinyl alcohol polymer (B-1) region. The type of vinyl alcohol polymer (B-1) is not particularly limited. For example, the vinyl alcohol polymer (B-1) is preferably polyvinyl alcohol or an ethylene-vinyl alcohol copolymer, as described below. The vinyl alcohol polymer (B-1) has a vinyl alcohol unit content of preferably 40 mol % or more relative to all structure units constituting the vinyl alcohol polymer (B-1). The vinyl alcohol unit content may be 50 mol % or more, or 55 mol % or more. The vinyl alcohol polymer (B-1) may be polyvinyl alcohol or an ethylene-vinyl alcohol copolymer used alone, or may be a combination of more than one polyvinyl alcohol and/or more than one ethylene-vinyl alcohol copolymer. In the present invention, a “structure unit” of a polymer means a repeating unit of a polymer. For example, “ethylene unit” and “vinyl alcohol unit” are both structure units.

Block Copolymer (B2)

In the case where the copolymer (B) is a block copolymer (B2), the block copolymer (B2) has the vinyl alcohol polymer (B-1) region as a polymer block (b1), and the diene polymer (B-2) region as a polymer block (b2). The block copolymer (B2) may have one polymer block (b1) and one polymer block (b2), or may have two or more polymer blocks (b1) and/or two or more polymer blocks (b2). As to the form of linkage, the block copolymer may be, for example, a linear multiblock copolymer such as a b1-b2 diblock copolymer, a b1-b2-b1 triblock copolymer, a b2-b1-b2 triblock copolymer, a b1-b2-b1-b2 tetrablock copolymer, or a b2-b1-b2-b1 tetrablock copolymer, or may be a star-shaped (radial star) block copolymer represented by, for example, (b2-b1-)n or (b1-b2-)n, where n is a number greater than two.

Vinyl Alcohol Polymer (B-1)

The viscosity-average degree of polymerization of the polyvinyl alcohol (measured in compliance with JIS K 6726 (1994)) is not particularly limited, and is preferably 100 to 10,000, more preferably 200 to 7,000, even more preferably 300 to 5,000. The resin composition obtained can have improved mechanical strength with a viscosity-average degree of polymerization confined within these ranges. In the vinyl alcohol polymer (B-1), the viscosity-average degree of polymerization can be adjusted according to the desired number average molecular weight of copolymer (B).

The degree of saponification of the polyvinyl alcohol (measured in compliance with JIS K 6726 (1994)) is not particularly limited. However, in view of providing superior heat stability and flexibility for the resin composition, the degree of saponification of the polyvinyl alcohol is preferably 50 mol % or more, more preferably 80 mol % or more, even more preferably 95 mol % or more. The degree of saponification of the polyvinyl alcohol may be 100 mol %.

The content of the ethylene unit in the ethylene-vinyl alcohol copolymer is not particularly limited. However, for ease of production and in view of providing superior heat stability and flexibility for the resin composition, the ethylene unit content of the ethylene-vinyl alcohol copolymer is preferably 10 to 60 mol %, more preferably 20 to 50 mol %. The ethylene unit content of the ethylene-vinyl alcohol copolymer can be determined by ¹H-NMR measurement.

The degree of saponification of the ethylene-vinyl alcohol copolymer is not particularly limited. However, in view of providing superior heat stability and flexibility for the resin composition, the degree of saponification of the ethylene-vinyl alcohol copolymer is preferably 90 mol % or more, more preferably 95 mol % or more, even more preferably 99 mol % or more. The degree of saponification of the ethylene-vinyl alcohol copolymer may be 100 mol %. The degree of saponification of the ethylene-vinyl alcohol copolymer can be determined in compliance with JIS K 6726 (1994).

The melt flow rate (MFR) of the ethylene-vinyl alcohol copolymer (210° C., a 2,160 g load) is not particularly limited, and is preferably at least 0.1 g/10 min, more preferably at least 0.5 g/10 min. The resin composition can have superior water resistance and mechanical strength with a melt flow rate of at least 0.1 g/10 min. The upper limit of melt flow rate may adopt a commonly used value, and may be, for example, at most 25 g/10 min. The melt flow rate refers to a value measured in compliance with ASTM D1238 under 210° C., 2,160 g load conditions using a melt indexer.

The polyvinyl alcohol and the ethylene-vinyl alcohol copolymer may comprise a structure unit (x) other than the vinyl alcohol unit, vinyl ester monomer unit, and ethylene unit, provided that it is not detrimental to the effects of the present invention.

Examples of the structure unit (x) include structure units derived from the following:

α-olefins such as propylene, n-butene, isobutylene, and 1-hexene (including ethylene in the case of polyvinyl alcohol);

acrylic acid;

unsaturated monomers having an acrylic acid ester group, such as methyl acrylate, ethyl acrylate, n-propyl acrylate, i-propyl acrylate, n-butyl acrylate, i-butyl acrylate, t-butyl acrylate, 2-ethylhexyl acrylate, dodecyl acrylate, and octadecyl acrylate;

methacrylic acid;

unsaturated monomers having a methacrylic acid ester group, such as methyl methacrylate, ethyl methacrylate, n-propyl methacrylate, i-propyl methacrylate, n-butyl methacrylate, i-butyl methacrylate, t-butyl methacrylate, 2-ethylhexyl methacrylate, dodecyl methacrylate, and octadecyl methacrylate;

acrylamides such as acrylamide, N-methylacrylamide, N-ethylacrylamide, N,N-dimethylacrylamide, diacetoneacrylamide, acrylamidepropanesulfonic acid, and acrylamidepropyldimethylamine;

methacrylamides such as methacrylamide, N-methylmethacrylamide, N-ethylmethacrylamide, methacrylamidepropanesulfonic acid, and meth acrylamidepropyldimethylamine;

vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, stearyl vinyl ether, and 2,3-diacetoxy-1-vinyloxypropane; unsaturated nitriles such as acrylonitrile, and methacrylonitrile;

vinyl halides such as vinyl chloride, and vinyl fluoride;

vinylidene halides such as vinylidene chloride, and vinylidene fluoride;

allyl compounds such as allyl acetate, 2,3-diacetoxy-1-allyloxypropane, and allyl chloride;

unsaturated dicarboxylic acids such as maleic acid, itaconic acid, and fumaric acid, and salts or esters thereof;

vinyl silyl compounds such as vinyltrimethoxysilane; and

isopropenyl acetate.

The content of the structure unit (x) is preferably less than 10 mol %, more preferably less than 5 mol % relative to all structure units constituting the polyvinyl alcohol or the ethylene-vinyl alcohol copolymer.

Particularly preferred for use as vinyl alcohol polymer (B-1) is an ethylene-vinyl alcohol copolymer. The heat stability and flexibility of the resin composition can more easily improve by using an ethylene-vinyl alcohol copolymer.

Diene Polymer (B-2)

The copolymer (B) comprises a diene polymer (B-2) region. The structure of the diene polymer (B-2) is not particularly limited; however, the diene polymer (B-2) preferably has an olefin structure. With the diene polymer (B-2) having an olefin structure, a resin composition of the present invention can be crosslinked or vulcanized under heat. Examples of the diene polymer (B-2) include polybutadiene, polyisoprene, polyisobutylene, polychloroprene, and polyfarnesene. These may be used alone, or two or more thereof may be used in combination. The diene polymer (B-2) may be a copolymer of two or more kinds of monomers selected from the group consisting of butadiene, isoprene, isobutylene, chloroprene, and farnesene. Preferred in view of reactivity and flexibility are polybutadiene, polyisoprene, and polyisobutylene, of which polyisoprene is more preferred. The copolymer (B) may have a structure unit other than the vinyl alcohol polymer (B-1) region and the diene polymer (B-2) region, provided that it does not interfere with the effects of the present invention.

In a resin composition of the present invention, the diene polymer (B-2) region in the graft copolymer (B1) exists preferably as a side chain, and, preferably, the diene polymer (B-2) region, in part or as a whole, is directly attached to a carbon atom constituting the main chain formed by the vinyl alcohol polymer (B-1) region, preferably a secondary or a tertiary carbon atom constituting the main chain. A resin composition of the present invention can have even superior heat stability and flexibility when the side chain, in part or as a whole, is directly attached to a secondary carbon atom or a tertiary carbon atom.

In the copolymer (B), the content of the diene polymer (B-2) region relative to the total mass of the vinyl alcohol polymer (B-1) region and the diene polymer (B-2) region is not particularly limited, and is preferably 30 mass % or more, more preferably 40 mass % or more, even more preferably 45 mass % or more. The content of the diene polymer (B-2) region is preferably 80 mass % or less, more preferably 76 mass % or less, even more preferably 70 mass % or less. When the content of the diene polymer (B-2) region is 30 mass % or more, the desired flexibility and reactivity can more easily be obtained. When the content of the diene polymer (B-2) region is 80 mass % or less, vinyl alcohol polymer (A) and copolymer (B) (particularly, the graft copolymer (B1)) can have improved compatibility in an embodiment comprising vinyl alcohol polymer (A), and it becomes easier to inhibit formation of coarse phase separation. This makes it easier to maintain desirable properties in the resin composition, including transparency.

In the copolymer (B), the content of the vinyl alcohol unit relative to the total mass of the vinyl alcohol polymer (B-1) region and the diene polymer (B-2) region preferably ranges from 15 mass % to 60 mass %. With a vinyl alcohol unit content of 15 mass % or more, vinyl alcohol polymer (A) and copolymer (B) (particularly, the graft copolymer (B1)) can have improved compatibility, and the resin composition can have improved transparency in an embodiment comprising vinyl alcohol polymer (A). With a vinyl alcohol unit content of 60 mass % or less, the vinyl alcohol polymer (A) and the copolymer (B) become moderately compatible, and it becomes easier to reduce decrease of matrix crystallinity caused when the compatibility is too high, and to inhibit deterioration of various properties due to decrease of matrix crystallinity. The vinyl alcohol unit content is more preferably 17 to 50 mass %, even more preferably 18 to 45 mass %, particularly preferably 20 to 40 mass %. The method of measurement of vinyl alcohol unit content is as described in the EXAMPLES section below.

It is preferable that the side chain formed by the diene polymer (B-2) region in graft copolymer (B1) have a molecular weight distribution. With a molecular weight distribution in the side chain formed by the diene polymer (B-2) region, the compatibility between vinyl alcohol polymer (A) and graft copolymer (B1) can more easily improve, and the transparency of the resin composition after molding tends to increase in an embodiment comprising vinyl alcohol polymer (A).

Vinyl Alcohol Polymer (A)

In certain preferred embodiments, the resin composition of the present invention further comprises a vinyl alcohol polymer (A). The type of vinyl alcohol polymer (A) is not particularly limited. For example, the vinyl alcohol polymer (A) is preferably polyvinyl alcohol or an ethylene-vinyl alcohol copolymer. In the vinyl alcohol polymer (A), the viscosity-average degree of polymerization and the degree of saponification of the polyvinyl alcohol or ethylene-vinyl alcohol copolymer, and the ethylene unit content and the melt flow rate of the ethylene-vinyl alcohol copolymer are the same as in the polyvinyl alcohol and ethylene-vinyl alcohol copolymer described above as vinyl alcohol polymer (B-1) in conjunction with copolymer (B). The vinyl alcohol polymer (A) and the vinyl alcohol polymer (B-1) may be the same or different with regard to properties such as the structure unit of the polymer, and the viscosity-average degree of polymerization and the degree of saponification of the polymer. The vinyl alcohol polymer (A) has a vinyl alcohol unit content of preferably 40 mol % or more relative to all structure units constituting the vinyl alcohol polymer (A). The vinyl alcohol unit content of the vinyl alcohol polymer (A) may be 50 mol % or more, or 55 mol % or more.

In a resin composition comprising the vinyl alcohol polymer (A), the content of copolymer (B) relative to total 100 parts by mass of vinyl alcohol polymer (A) and copolymer (B) is preferably 10 to 90 mass %. In view of further improvements of heat stability and flexibility of the resin composition, the content of copolymer (B) is more preferably 30 to 85 mass %, even more preferably 35 to 75 mass %.

Phenol-Based Compound (C), Amine-Based Compound (D), and Phosphorus-Based Compound (E)

A resin composition of the present invention comprises at least one compound selected from the group consisting of a phenol-based compound (C), an amine-based compound (D), and a phosphorus-based compound (E), in addition to the copolymer (B).

Phenol-Based Compound (C)

The phenol-based compound (C) has a molecular weight of preferably 100 or more and 2,000 or less. In view of heat stability and flexibility of the resin composition, the molecular weight of phenol-based compound (C) is more preferably 150 or more and 1,500 or less, even more preferably 160 or more and 1,200 or less. By using phenol-based compound (C), the oxidation reaction of the diene polymer (B-2) region of copolymer (B) can be inhibited in a specific fashion. That is, it is possible to inhibit generation of a carbonyl group in the diene polymer (B-2) region of copolymer (B). In this way, the resin composition can have improved heat stability by preventing the reaction between the carbonyl group generated in the diene polymer (B-2) region of copolymer (B), and the hydroxyl group of the vinyl alcohol polymer (B-1) region, or the reaction between the generated carbonyl group and the hydroxyl group of the vinyl alcohol polymer (A) when the vinyl alcohol polymer (A) is contained. By using phenol-based compound (C) with the copolymer (B), it is also possible to impart moderate flexibility to the resin composition. The resin composition can also have reduced discoloration with the phenol-based compound (C).

Preferably, the phenol-based compound (C) is a compound represented by the following general formula [I] or [II],

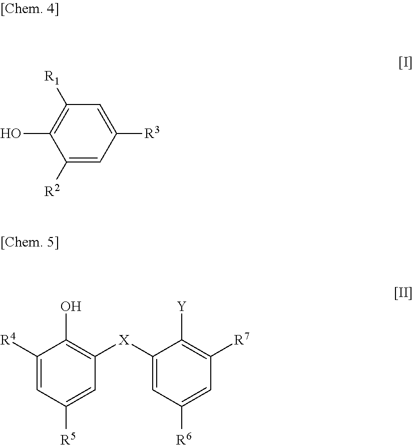

wherein R¹ to R⁷ each independently represent a hydrocarbon group having 1 to 15 carbon atoms, X represents a divalent hydrocarbon group having 1 to 15 carbon atoms, and Y represents a vinyloxy group (—O—CH═CH2) or a (meth)acryloyloxy group, where the hydrocarbon groups represented by R¹ to R⁷ and X may contain at least one kind of group selected from the group consisting of —O—, —S—, —NH—, —N(R⁸)—, —O(CO)—, and —CO—, where R⁸ represents a hydrocarbon group having 1 to 6 carbon atoms.

The hydrocarbon groups having 1 to 15 carbon atoms represented by R¹ to R⁷ may be linear or branched. Examples of such hydrocarbon groups include:

alkyl groups such as methyl, ethyl, n-propyl, isopropyl, n-butyl, isobutyl, sec-butyl, 2-methylpropyl, tert-butyl, n-pentyl, isopentyl, sec-pentyl, neopentyl, 1-ethylpropyl, 1,1-dimethylpropyl, 1,2-dimethylpropyl, n-hexyl, 1-methylpentyl, 2-methylpentyl, 3-methylpentyl, 4-methylpentyl (isohexyl), 1-ethylbutyl, 2-ethylbutyl, 1,1-dimethylbutyl, 1,2-dimethylbutyl, 1,3-dimethylbutyl, 1,4-dimethylbutyl, 2,2-dimethylbutyl, 2,3-dimethylbutyl, 3,3-dimethylbutyl, 1-ethyl-2-methyl-propyl, 1,1,2-trimethylpropyl, n-heptyl, 2-methylhexyl, n-octyl, isooctyl, tert-octyl, 2-ethylhexyl, 3-methylheptyl, n-nonyl, n-decyl, 1-methylnonyl, n-undecyl, and n-dodecyl;

alkenyl groups such as vinyl, 1-propenyl, 2-propenyl (1-methyl)ethenyl, 2-butenyl, 3-butenyl, 1,3-butadienyl, and 2-pentenyl; and

aryl groups such as phenyl, substituted phenyl, and naphthyl.

Examples of the substituent of the substituted phenyl include linear or branched alkyl groups having 1 to 10 carbon atoms, and halogen atoms (a fluorine atom, a chlorine atom, a bromine atom, an iodine atom). In view of further improvements of heat stability and flexibility of the resin composition, the hydrocarbon groups having 1 to 15 carbon atoms represented by R¹ to R⁷ are preferably linear or branched alkyl groups. The hydrocarbon groups represented by R¹ to R⁷ have preferably 1 to 10 carbon atoms. In view of further improvements of heat stability and flexibility of the resin composition, the number of carbon atoms is more preferably 1 to 6. Examples of the hydrocarbon group represented by R⁸ include the hydrocarbon groups exemplified above for R¹ to R⁷ and having 1 to 6 carbon atoms. The divalent hydrocarbon group having 1 to 15 carbon atoms represented by X may be linear or branched. Examples of such divalent hydrocarbon groups include alkylene groups such as a methylene group, a methylmethylene group, an ethylene group, an n-propylene group, an isopropylene group, a butylene group, a pentylene group, a hexylene group, a heptylene group, an octylene group, a nonylene group, and a decylene group. The hydrocarbon group represented by X has preferably 1 to 10 carbon atoms. In view of further improvements of heat stability and flexibility of the resin composition, the number of carbon atoms is more preferably 1 to 6, even more preferably 1 to 4. In view of further improvements of heat stability and flexibility of the resin composition, Y is preferably a (meth)acryloyloxy group, more preferably an acryloyloxy group. In certain preferred embodiments, the phenol-based compound may be a compound in which the hydrocarbon groups represented by R¹ to R⁷ and X do not contain —O—, —S—, —NH—, —N(R⁸)—, —O(CO)—, or —CO—.

In another embodiment, the phenol-based compound (C) may be a compound represented by the following general formula [III],

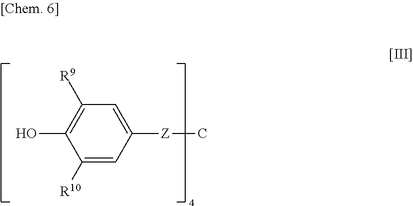

wherein R⁹ and R¹⁰ each independently represent a hydrocarbon group having 1 to 15 carbon atoms, Z represents a divalent hydrocarbon group having 1 to 15 carbon atoms, where the hydrocarbon groups represented by R⁹, R¹⁰, and Z may contain at least one kind of group selected from the group consisting of —O—, —S—, —NH—, —N(RH)—, —O(CO)—, and —CO—, where RH represents a hydrocarbon group having 1 to 6 carbon atoms.

The hydrocarbon groups represented by R⁹ and R¹⁰ may be the same hydrocarbon groups exemplified for R¹ to R⁷. The hydrocarbon group represented by R¹¹ may be the same hydrocarbon groups exemplified for R⁸. Preferably, compounds represented by general formula [III] are compounds in which R⁹ and R¹⁰ are hydrocarbon groups having 1 to 6 carbon atoms, Z is a divalent hydrocarbon group having 1 to 10 carbon atoms, and the divalent hydrocarbon group contains at least one kind of group selected from the group consisting of —O—, —S—, —NH—, —N(RH)—, —O(CO)—, and —CO—.

In certain preferred embodiments, in view of further improving the heat stability and flexibility of the resin composition and more effectively inhibiting bleeding and more effectively preventing discoloration, the phenol-based compound (C) may be a phenol-based compound represented by general formula [I] and in which R¹, R², and R³ are hydrocarbon groups having 1 to 6 carbon atoms.

In other preferred embodiments, in view of further improving the heat stability and flexibility of the resin composition and more effectively preventing discoloration, the phenol-based compound (C) may be a phenol-based compound represented by general formula [II] and in which R⁴, R⁵, R⁶, and R⁷ are hydrocarbon groups having 1 to 6 carbon atoms, X is a divalent hydrocarbon group having 1 to 6 carbon atoms, and Y is an acryloyloxy group.

Examples of the phenol-based compound (C) include dibutylhydroxytoluene, mono(α-methylbenzyl)phenol, di(α-methylbenzyl)phenol, tri(α-methylbenzyl)phenol, 2,5-di-t-butylhydroquinone, 2,5-di-t-amylhydroquinone, 2-[1-(2-hydroxy-3,5-di-t-pentylphenyl)ethyl]-4,6-di-t-pentylphenyl acrylate, 2-t-butyl-6-(3-t-butyl-2-hydroxy-5-methylbenzyl)-4-methylphenyl acrylate, 4,6-bis[(octylthio)methyl]-o-cresol, pentaerythritol tetrakis[3-(3,5-di-t-butyl-4-hydroxyphenyl)propionate], 2,2′-methylenebis(4-methyl-6-t-butylphenol), 2,2′-methylenebis(4-ethyl-6-t-butylphenol), 4,4′-butylidenebis(3-methyl-6-t-butylphenol), and octadecyl-3-(3,5-di-t-butyl-4-hydroxyphenyl)propionate. In view of further improvements of heat stability and flexibility of the resin composition, preferred are dibutylhydroxytoluene, 2-[1-(2-hydroxy-3,5-di-t-pentylphenyl)ethyl]-4,6-di-t-pentylphenyl acrylate, 2-t-butyl-6-(3-t-butyl-2-hydroxy-5-methylbenzyl)-4-methylphenyl acrylate, and 2-t-butyl-6-(3-t-butyl-2-hydroxy-5-methylbenzyl)-4-methylphenyl acrylate. The phenol-based compound (C) may be used alone, or two or more thereof may be used in combination.

In view of further improvements of heat stability and flexibility of the resin composition, the phenol-based compound (C) is preferably at least one selected from the group consisting of dibutylhydroxytoluene, and 2-[1-(2-hydroxy-3,5-di-t-pentylphenyl)ethyl]-4,6-di-t-pentylphenyl acrylate.

In view of heat stability and flexibility of the resin composition, the content of phenol-based compound (C) is preferably 0.05 to 15 parts by mass, more preferably 0.1 to 10 parts by mass per 100 parts by mass of the resin composition. In view of more effectively inhibiting bleeding and more effectively preventing discoloration, the content of phenol-based compound (C) is more preferably 1 to 8 parts by mass. The content of a compound represented by general formula [I] is preferably 2 to 15 parts by mass, more preferably 3 to 10 parts by mass, even more preferably 4 to 8 parts by mass per 100 parts by mass of the resin composition. The content of a compound represented by general formula [II] is preferably 5 to 15 parts by mass, more preferably 5 to 12 parts by mass, even more preferably 5 to 9 parts by mass per 100 parts by mass of the resin composition.

Amine-Based Compound (D)

The amine-based compound (D) has a molecular weight of preferably 100 or more and 2,000 or less. In view of heat stability and flexibility of the resin composition, the molecular weight of amine-based compound (D) is more preferably 150 or more and 1,500 or less, even more preferably 160 or more and 1,200 or less. By using amine-based compound (D), the oxidation reaction of the diene polymer (B-2) region of copolymer (B) can be inhibited in a specific fashion. That is, it is possible to inhibit generation of a carbonyl group in the diene polymer (B-2) region of copolymer (B). In this way, the resin composition can have improved heat stability by preventing the reaction between the carbonyl group generated in the diene polymer (B-2) region of copolymer (B), and the hydroxyl group of the vinyl alcohol polymer (B-1) region, or the reaction between the generated carbonyl group and the hydroxyl group of the vinyl alcohol polymer (A) when the vinyl alcohol polymer (A) is contained. By using amine-based compound (D) with the copolymer (B), it is also possible to impart moderate flexibility to the resin composition. The amine-based compound (D) can inhibit generation of the carbonyl group, and improve the heat stability and flexibility of the resin composition even when contained in small amounts.

In view of heat stability and flexibility of the resin composition, the amine-based compound (D) is preferably an amine having an aromatic group (excluding benzimidazole compounds, for example, 2-mercaptobenzimidazole). Examples of the aromatic group include aryl groups such as phenyl, substituted phenyl, and naphthyl. The aromatic group is preferably phenyl. Examples of the substituent of the substituted phenyl include linear or branch alkyl groups having 1 to 10 carbon atoms, and halogen atoms (a fluorine atom, a chlorine atom, a bromine atom, an iodine atom). In view of further improvements of heat stability and flexibility of the resin composition, the amine having an aromatic group is preferably a secondary amine having two or more aromatic rings, or a tertiary amine having two or more aromatic rings. The number of aromatic rings contained in the amine having an aromatic group is not particularly limited, and may be 2 to 6, 2 to 4, or 2 to 3.

The secondary amine having two or more aromatic rings is, for example, a compound represented by the following general formula [IV],

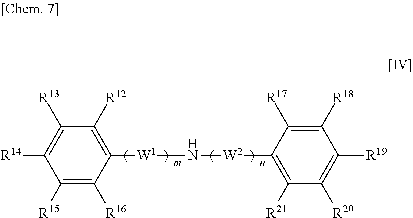

wherein R¹² to R²¹ each independently represent a hydrogen atom or a hydrocarbon group having 1 to 15 carbon atoms, W¹ and W² represent divalent hydrocarbon groups having 1 to 15 carbon atoms, and m and n are each independently 0 or 1, where the hydrocarbon groups represented by R¹² to R²¹ and W¹ and W² may contain at least one kind of group selected from the group consisting of —O—, —S—, —NH—, —N(R²²)—, —O(CO)—, and —CO—, and wherein R¹² to R²¹ may together form a ring, and R²² represents a hydrocarbon group having 1 to 6 carbon atoms.

The hydrocarbon groups having 1 to 15 carbon atoms represented by R¹² to R²¹ may be the same hydrocarbon groups exemplified for R¹ to R⁷. The divalent hydrocarbon groups having 1 to 15 carbon atoms represented by W¹ and W² may be the same divalent hydrocarbon groups exemplified for X. The ring formed together by R¹² to R²¹ may be an aromatic ring, or a heterocyclic ring containing an oxygen atom or a sulfur atom. For example, R¹² and R¹⁷ may together form a heterocyclic ring containing a sulfur atom and a nitrogen atom, via S.

Preferably, compounds represented by general formula [IV] are amines having a diarylamine skeleton and in which m and n are 0. Compounds represented by general formula [IV] include compounds in which R¹² to R²¹ are all hydrogen atoms, m and n are 0, and R¹² and R¹⁷ are forming a heterocyclic ring via —S— and/or R¹⁶ and R²¹ are forming a heterocyclic ring via —S—.

Examples of the amine-based compound (D) include amines having a diarylamine skeleton, for example, such as N-phenyl-1-naphthylamine, di(4-butylphenyl)amine, di(4-pentylphenyl)amine, di(4-hexylphenyl)amine, di(4-heptylphenyl)amine, di(4-octylphenyl)amine, 4,4′-bis(α, α-dimethylbenzyl)diphenylamine, p-(p-toluenesulfonylamide)diphenylamine, N,N′-di(2-naphthyl)-p-phenylenediamine, N-phenyl-N′-isopropyl-p-phenylenediamine, N-phenyl-N′-(1,3-dimethylbutyl)-p-phenylenediamine, N-phenyl-N′-(3-methacryloyloxy-2-hydroxypropyl)-p-phenylenediamine, 2,3:5,6-dibenzo-1,4-thiazine, N,N,N′N′-tetramethyl-p-diaminodiphenylmethane, and diphenylamine. In view of heat stability and flexibility of the resin composition, the resin composition preferably comprises at least one selected from the group consisting of 4,4′-bis(α, α-dimethylbenzyl)diphenylamine, N-phenyl-N′-isopropyl-p-phenylenediamine, N-phenyl-N′-(1,3-dimethylbutyl)-p-phenylenediamine, 2,3:5,6-dibenzo-1,4-thiazine, and N,N,N′N′-tetramethyl-p-diaminodiphenylmethane. The amine-based compound (D) may be used alone, or two or more thereof may be used in combination.

In view of heat stability and flexibility of the resin composition, the content of amine-based compound (D) is preferably 0.05 to 15 parts by mass, more preferably 0.1 to 8 parts by mass per 100 parts by mass of the resin composition. In view of further improvement of the heat stability of the resin composition with smaller amounts of amine-based compound (D), the content of amine-based compound (D) is more preferably 1 to 5 parts by mass.

Phosphorus-Based Compound (E)

The phosphorus-based compound (E) has a molecular weight of preferably 100 or more and 2,000 or less. In view of heat stability and flexibility of the resin composition, the molecular weight of phosphorus-based compound (E) is more preferably 150 or more and 1,500 or less, even more preferably 160 or more and 1,200 or less. By using phosphorus-based compound (E), the oxidation reaction of the diene polymer (B-2) region of copolymer (B) can be inhibited in a specific fashion. That is, it is possible to inhibit generation of a carbonyl group in the copolymer (B). In this way, the resin composition can have improved heat stability by preventing the reaction between the carbonyl group generated in the diene polymer (B-2) region of copolymer (B), and the hydroxyl group of the vinyl alcohol polymer (B-1) region, or the reaction between the generated carbonyl group and the hydroxyl group of the vinyl alcohol polymer (A) when the vinyl alcohol polymer (A) is contained. By using phosphorus-based compound (E) with the copolymer (B), it is also possible to impart moderate flexibility to the resin composition. The phosphorus-based compound (E) can inhibit generation of the carbonyl group, and improve the heat stability and flexibility of the resin composition even when contained in small amounts.

Preferably, the phosphorus-based compound (E) is a trivalent phosphite ester. The trivalent phosphite ester may be, for example, a compound represented by the following general formula [V], [VI], or [VII],

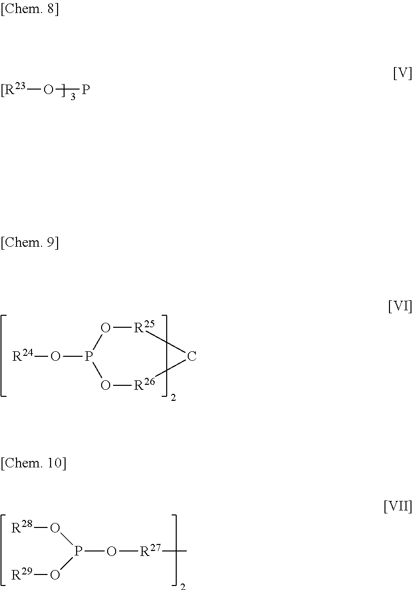

wherein R²³, R²⁴, R²⁸, and R²⁹ each independently represent a hydrocarbon group having 1 to 25 carbon atoms, R²⁵ to R²⁷ each independently represent a divalent hydrocarbon group having 1 to 25 carbon atoms, and the plurality of R²³ may together form a ring.

The hydrocarbon groups having 1 to 25 carbon atoms represented by R²³, R²⁴, R²⁸, and R²⁹ may be linear or branched. Examples of such hydrocarbon groups include aliphatic groups such as alkyl having 1 to 25 carbon atoms, and alkenyl having 2 to 25 carbon atoms; and aromatic groups having 6 to 25 carbon atoms. The aliphatic group is preferably alkyl having 3 to 20 carbon atoms, more preferably alkyl having 4 to 19 carbon atoms. Examples of the aromatic groups include aryl groups such as phenyl, substituted phenyl, and naphthyl. Preferred are phenyl and substituted phenyl. Examples of the substituent of the substituted phenyl include linear or branched alkyl groups having 1 to 10 carbon atoms, and halogen atoms (a fluorine atom, a chlorine atom, a bromine atom, an iodine atom). The plurality of R²³, R²⁴, R²⁸, and R²⁹ may be the same or different. The divalent hydrocarbon groups having 1 to 25 carbon atoms represented by R²⁵ to R²⁷ may be linear or branched. Examples of such divalent hydrocarbon groups include divalent aliphatic groups such as an alkylene group having 1 to 25 carbon atoms, and an alkenylene group having 2 to 25 carbon atoms; and divalent aromatic groups having 6 to 25 carbon atoms. The aliphatic group is preferably an alkylene group having 1 to 20 carbon atoms, more preferably an alkylene group having 1 to 10 carbon atoms. Examples of the alkylene group include a methylene group, a methylmethylene group, an ethylene group, an n-propylene group, an isopropylene group, a butylene group, a pentylene group, a hexylene group, a heptylene group, an octylene group, a nonylene group, and a decylene group. Examples of the divalent aromatic groups include arylene groups such as a phenylene group, a substituted phenylene group, and a naphthylene group. Examples of the substituent of the substituted phenylene group include the same substituents exemplified for the substituted phenyl. The plurality of R²⁵ to R²⁷ may be the same or different. In certain preferred embodiments, the phosphorus-based compound (E) is a compound represented by general formula [V] and in which R²³ is a substituted phenyl group substituted with linear or branched alkyl having 1 to 10 carbon atoms, and the three R²³ are all the same.

Examples of the phosphorus-based compound (E) include tris(nonylphenyl)phosphite, triphenyl phosphite, tristearyl phosphite, tricresyl phosphite, tris(2,4-di-tert-butylphenyl)phosphite, tris(2-ethylhexyl)phosphite, tridecyl phosphite, trilauryl phosphite, tris(tridecyl)phosphite, trioleyl phosphite, diphenyl mono(2-ethylhexyl)phosphite, diphenyl monodecyl phosphite, diphenyl mono(tridecyl)phosphite, 2,2′-methylenebis(4,6-di-tert-butylphenyl)2-ethylhexyl phosphite, bis(decyl)pentaerythritol diphosphite, bis(tridecyl)pentaerythritol diphosphite, and distearyl pentaerythritol diphosphite. Preferred is tris(nonylphenyl)phosphite. The phosphorus-based compound (E) may be used alone, or two or more thereof may be used in combination.

In certain preferred embodiments of a resin composition of the present invention, the resin composition may comprise a combination of phenol-based compound (C) and amine-based compound (D), a combination of phenol-based compound (C) and phosphorus-based compound (E), a combination of amine-based compound (D) and phosphorus-based compound (E), or a combination of phenol-based compound (C), amine-based compound (D), and phosphorus-based compound (E), provided that the effects of the present invention can be obtained. A resin composition comprising phenol-based compound (C) and phosphorus-based compound (E), or a resin composition comprising amine-based compound (D) and phosphorus-based compound (E) are effective, and a resin composition comprising amine-based compound (D) and phosphorus-based compound (E) are particularly effective. The total content of phenol-based compound (C), amine-based compound (D), and phosphorus-based compound (E) is preferably 0.05 to 15 parts by mass, more preferably 0.1 to 10 parts by mass per 100 parts by mass of the resin composition. In a more preferred embodiment, the content is 0.1 to 1.0 part by mass. In a particularly preferred embodiment, the content is 0.1 to 0.6 parts by mass. When a resin composition of the present invention is containing a phosphorus-based compound (E) and at least one compound selected from the group consisting of a phenol-based compound (C) and an amine-based compound (D), the proportions of these compounds are not particularly limited. It is, however, preferable that such a resin composition have a mass ratio (W_{CD}/W_{E}) of 90/10 to 50/50, where W_{CD} is the mass of at least one compound selected from the group consisting of a phenol-based compound (C) and an amine-based compound (D), and W_{E} is the mass of the phosphorus-based compound (E). The effect of using two kinds of compounds can more easily be produced when the mass ratio is confined in this range. The mass ratio (W_{CD}/W_{E}) is preferably 85/15 to 55/45, more preferably 80/20 to 60/40.

A resin composition of the present invention may comprise other resin (F) and other additive (G). Examples of such other resin (F) include polyamide resin, acrylic resin, polyolefinic resin, modified polyolefin resin, vinyl chloride resin, polylactic acid resin, and cellulose resin. These resins (F) may be used alone, or two or more thereof may be used in combination. In certain embodiments, a resin composition of the present invention is preferably essentially free of other resin (F). Here, being essentially free of some component means that the content of the component in the resin composition is less than 5 mass %, preferably less than 1 mass %, more preferably less than 0.1 mass %, even more preferably less than 0.01 mass %. Examples of other additive (G) include a light stabilizer, an antiblocking agent, a pigment, a dye, and a heat shielding material.

Preferably, a resin composition of the present invention has an absorbance difference of less than 0.01 for a peak at 1,719 cm⁻¹ when a FT-IR spectrum of a resin composition before press molding at 200° C. for 600 seconds is superimposed on a FT-IR spectrum of a molded body (for example, a film) after press molding at 200° C. for 600 seconds. The resin composition can have desirable heat stability with an absorbance difference falling in this range. The FT-IR measurement can be performed using the method described in the EXAMPLES section below.

A resin composition of the present invention has a tensile elastic modulus of preferably 5 to 150 kgf/mm², more preferably 10 to 100 kgf/mm² in the form of a 100 μm thick film molded by being pressed at 200° C. for 600 seconds. Preferably, the film has a fracture elongation of 10 to 200%. The resin composition can have desirable flexibility with the fracture elongation falling in this range. Tensile elastic modulus and fracture elongation can be measured with an Autograph using the method described in the EXAMPLES section below.

A method for producing a resin composition of the present invention is not particularly limited. As an example, the following describes a method of production of when the copolymer (B) is a graft copolymer (B1). The graft copolymer (B1) is produced by, for example, generating a radical on a main chain of a vinyl alcohol polymer, and introducing a graft chain using various graft polymerization methods commonly known in the art, and the graft copolymer (B1) produced is mixed with at least one compound selected from the group consisting of a phenol-based compound (C), an amine-based compound (D), and a phosphorus-based compound (E), and optionally with a vinyl alcohol polymer (A), in desired proportions. An example of a resin composition producing method comprises the steps of:

irradiating a vinyl alcohol polymer (B-1) with an active energy ray;

graft polymerizing the vinyl alcohol polymer (B-1) after the active energy ray irradiation by dispersing the vinyl alcohol polymer (B-1) in a raw material monomer of a diene polymer (B-2) or in a solution containing the monomer; and mixing a graft copolymer (B1) with at least one compound selected from the group consisting of a phenol-based compound (C), an amine-based compound (D), and a phosphorus-based compound (E), wherein the graft copolymer (B1) is a graft copolymer obtained in the graft polymerization step and that is constituted of a main chain formed by a vinyl alcohol polymer (B-1) region and a side chain formed by a diene polymer (B-2) region,

the resin composition comprising 0.05 to 15 parts by mass of at least one compound selected from the group consisting of a phenol-based compound (C), an amine-based compound (D), and a phosphorus-based compound (E) per 100 parts by mass of the resin composition.

Optionally, in the mixing step, a vinyl alcohol polymer (A) existing as an unreacted part of the vinyl alcohol polymer (B-1) in the graft polymerization step may be mixed with the graft copolymer (B1) and with at least one compound selected from the group consisting of a phenol-based compound (C), an amine-based compound (D), and a phosphorus-based compound (E).

A resin composition of the present invention has superior flexibility and excellent flex resistance with maintained barrier properties, and is useful as a molded body in various applications, including, for example, vertical form fill seal bag, vacuum packaging bags, pouches, laminated tubes, transfusion bags, paper containers, strip tapes, packaging materials for medicine, food, and daily commodities (e.g., lid materials for containers, and in-mold labeled containers); industrial barrier films such as cover films and soil sheets for agricultural use; and tires (inner liners, treads). The molded body may have a form of a film comprising a resin composition of the present invention, depending on use.

The present invention encompasses embodiments combining the foregoing features, provided that such combinations made in various forms within the technical idea of the present invention can produce the effects of the present invention. In the present specification, the upper limits and lower limits of numeric ranges (for example, ranges of contents of components, ranges of values calculated from components, and numeric ranges of physical properties) can be combined appropriately.

### EXAMPLES

The following describes the present invention in greater detail by way of Examples. It should be noted that the present invention is in no way limited by the following Examples, and various changes may be made by a person with ordinary skill in the art within the technical idea of the present invention. In the following Examples and Comparative Examples, “%” and “part(s)” are “mass %” and “part(s) by mass”, respectively, unless otherwise specifically stated.

Calculation of Mass Ratio of Vinyl Alcohol Polymer (A) and Graft Copolymer (B1) of Resin Composition

A resin composition obtained through graft polymerization reaction in the Synthesis Example below was added to an extraction solvent (water in the case of polyvinyl alcohol, and a 4:6 mixture of water and isopropanol (mass ratio) in the case of ethylene-vinyl alcohol copolymer), and an extraction process was carried out at 80° C. for 3 hours. After evaporating the extractant, the mass of the resulting extract, and the mass of the unextracted residue were measured. The mass of the extract is the mass (represented by “Wa”) of the vinyl alcohol polymer (A) contained in the resin composition, and the mass of the unextracted residue is the mass (represented by “Wb”) of the graft copolymer (B1) contained in the resin composition. The measured values were used to calculate the mass ratio (A)/(B1). A ¹H-NMR analysis of the extract confirmed that the extract from the extraction process was solely vinyl alcohol polymer (A), and did not contain graft copolymer (B1). The denominator of the mass ratio can be expressed as the content (mass %) of the graft copolymer (B1) relative to total 100 parts by mass of the vinyl alcohol polymer (A) and the graft copolymer (B1).

Calculation of Content Ratio of Diene Polymer (B-2) Region with respect to Total Mass of Vinyl Alcohol Polymer (B-1) Region and Diene Polymer (B-2) Region

The mass difference between Wab and the mass of the vinyl alcohol polymer (B-1) used for reaction is Wq, where Wab is the mass of the resin composition obtained in each Synthesis Example. The difference between Wab and Wa (Wab-Wa) is the mass Wb of graft copolymer (B1), where Wa is the mass of the vinyl alcohol polymer (A) in the resin composition calculated using the foregoing method. The content ratio of the side chain formed by the diene polymer (B-2) region with respect to the total mass of the main chain formed by the vinyl alcohol polymer (B-1) region and the side chain formed by the diene polymer (B-2) region was calculated by using Wb-Wq as the mass of the main chain formed by the vinyl alcohol polymer (B-1) region, and Wq as the mass of the side chain formed by the diene polymer (B-2) region.

Calculation of Total Degree of Modification

For calculations, the mass % of the ethylene unit of the raw-material ethylene-vinyl alcohol copolymer was denoted as a2, and the mass % of the vinyl alcohol unit was denoted as b₂. The total degree of modification (the content of monomers that underwent graft polymerization, relative to all monomer units of the resin composition obtained in Example) was calculated using the following formula.

Degree of modification [mol %]=Z₂/(X₂+Y₂+Z₂)×100

In the formula, X₂, Y₂, and Z₂ are values calculated by using the following mathematical formulae.

X₂={(raw-material ethylene-vinyl alcohol copolymer (parts by mass))×(a₂/100)}/28

Y₂={(raw-material ethylene-vinyl alcohol copolymer (parts by mass))×(b₂/100)}/44

Z₂={(resin composition after reaction (parts by mass))−(raw-material ethylene-vinyl alcohol copolymer (parts by mass))}/(molecular weight of monomer subjected to graft polymerization)

Calculation of Content Ratio of Vinyl Alcohol Unit Contained in Graft Copolymer (B1)

Calculations were made according to the following formulae, using Wb (mass of graft copolymer (B1)), Wb-Wq (mass of the main chain formed by vinyl alcohol polymer in graft copolymer (B1)), and b₂ (mass % of vinyl alcohol unit in ethylene-vinyl alcohol copolymer).

Content Ratio [%] of Vinyl Alcohol Unit={(Wb−Wq)×b₂/100}/Wb×100

Evaluation of Heat Stability

The compounds of Examples and Comparative Examples were press molded at 200° C. for 600 seconds to fabricate films having a thickness of 100 μm. The films were subjected to FT-IR analysis under the conditions below, and were determined as “Satisfactory” when there was no confirmed peak generation at 1,719 cm⁻¹ (a peak position corresponding to the carbonyl group), and “Unsatisfactory” when generation of a peak was confirmed at 1,719 cm⁻¹. For determination of peak generation, a FT-IR spectrum of the resin composition before compound molding was superimposed on a FT-IR spectrum obtained after molding, and the film was determined as having generated a peak when it had an absorbance difference of 0.01 or more for a peak at 1,719 cm⁻¹.

Device: Fourier transformation infrared spectrophotometer JIR-5500 (manufactured by JEOL Ltd.)

Mode: Attenuated total reflection (ATR) method Measurement range: 500 to 4,000 cm⁻¹

Number of scans: 32

Evaluation of Mechanical Strength

The compounds of Examples and Comparative Examples were press molded at 200° C. for 600 seconds to fabricate films having a thickness of 100 μm. The films were cut into a dumbbell shape, 10 mm wide, and were moisturized in a 20° C., 30% RH storage environment for 1 week. The films were then measured for tensile elastic modulus and fracture elongation using an Autograph (Shimadzu Corporation AG-5000B; load cell: 1 kN, pull rate: 500 mm/min, distance between chucks: 70 mm). The values shown in the table are mean values from five measurements.

### Synthesis Example 1

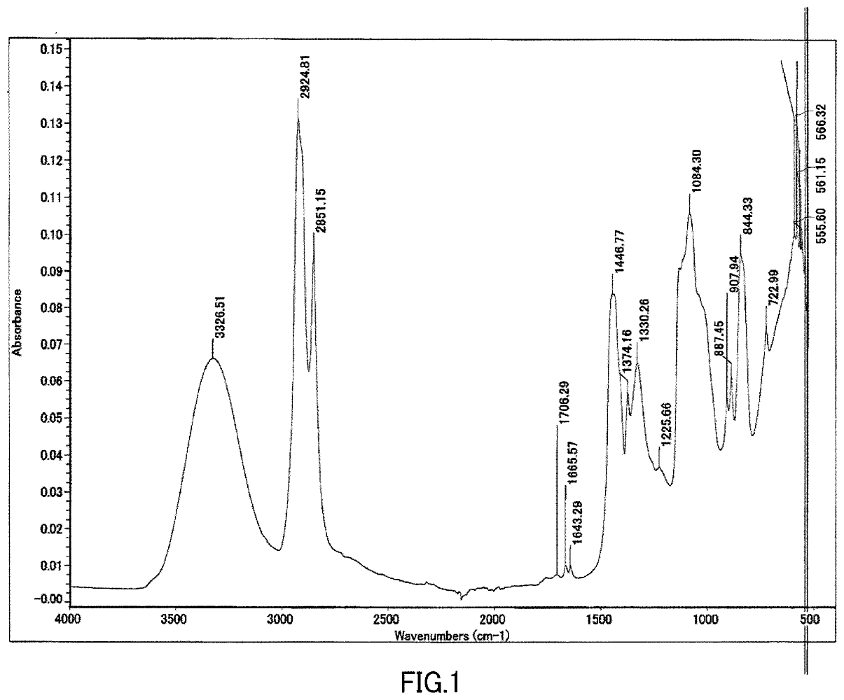

A commercially available ethylene-vinyl alcohol copolymer (F101 manufactured by Kuraray Co., Ltd.; ethylene unit content: 32 mol %, mass fraction of ethylene: 23.0 mass %) was pulverized, and classified with a 425 μm mesh sieve and a 710 μm mesh sieve to obtain particles having a particle size distribution of 425 μm to 710 μm. After classification, 100 parts by mass of the particles was irradiated with an electron beam (30 kGy). Separately, 570 parts by mass of isoprene was charged into an autoclave equipped with a stirrer, a nitrogen conduit, and a particle feed port, and inside of the system was replaced with nitrogen for 30 minutes by bubbling nitrogen in an ice-cooled state. The autoclave was then charged with 100 parts by mass of the ethylene-vinyl alcohol copolymer that had been irradiated with an electron beam, and, after sealing the autoclave, the whole was heated until the inner temperature reached 65° C. With the particles being dispersed in the liquid, the mixture was continuously heated for 4 hours with stirring to allow graft polymerization. After filtration, the collected particles were rinsed with tetrahydrofuran, and dried overnight in a vacuum at 40° C. to yield a raw-material resin composition containing an ethylene-vinyl alcohol copolymer and a graft copolymer. Details are shown in Table 1. FIG. 1 shows the result of the FT-IR analysis of the resin composition.

### Synthesis Example 2

A commercially available ethylene-vinyl alcohol copolymer (E105 manufactured by Kuraray Co., Ltd.; ethylene unit content: 44 mol %, mass fraction of ethylene: 33.3 mass %) was pulverized, and classified with a 75 μm mesh sieve and a 212 μm mesh sieve to obtain particles having a particle size distribution of 75 μm to 212 μm. After classification, 100 parts by mass of the particles was irradiated with an electron beam (30 kGy). Thereafter, 100 parts by mass of the ethylene-vinyl alcohol copolymer irradiated with an electron beam was charged into an autoclave equipped with a stirrer, a nitrogen conduit, and a particle feed port, and inside of the system was replaced with nitrogen by repeating the cycle of nitrogen sealing and system depressurization 5 times. The autoclave was then charged with 250 parts by mass of liquefied butadiene, and, after sealing the autoclave, the whole was heated until the inner temperature reached 65° C. The mixture was continuously heated for 4 hours with stirring to allow graft polymerization. The remaining butadiene was removed after cooling to ordinary temperature. After reaction, the particles were rinsed with tetrahydrofuran, and dried overnight in a vacuum at 40° C. to yield a polymer composition containing an ethylene-vinyl alcohol copolymer and a graft copolymer. Details are shown in Table 1.

### Example 1

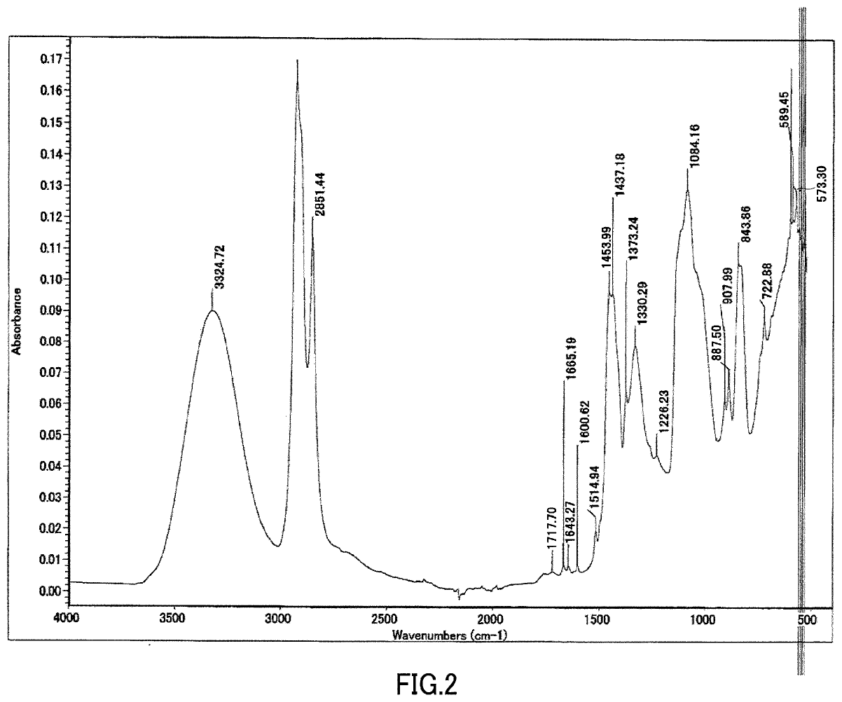

In Example 1, 99.5 parts by mass of the polymer composition obtained in Synthesis Example 1 was dry blended with 0.5 parts by mass of N-phenyl-N′-(1,3-dimethylbutyl)-p-phenylenediamine used as amine-based compound (D). The mixture was melt kneaded at 190° C. for 3 minutes using a Labo Plastomill, and the melt was cooled to solidify into a compound. The compound had no observable bleeding of amine-based compound (D) under visual inspection. Table 2 shows the results of the evaluations of various properties performed for the compound. FIG. 2 shows the result of the FT-IR analysis of a film molded from the compound.

### Example 2

In Example 2, 99.0 parts by mass of the polymer composition obtained in Synthesis Example 2 was dry blended with 1.0 part by mass of N-phenyl-N′(1,3-dimethylbutyl)-p-phenylenediamine used as amine-based compound (D). The mixture was melt kneaded at 190° C. for 3 minutes using a Labo Plastomill, and the melt was cooled to solidify into a compound. The compound had no observable bleeding of amine-based compound (D) under visual inspection. Table 2 shows the results of the evaluations of various properties performed for the compound.

### Example 3

In Example 3, 99.5 parts by mass of the polymer composition obtained in Synthesis Example 1 was dry blended with 0.5 parts by mass of 2,3:5,6-dibenzo-1,4-thiazine used as amine-based compound (D). The mixture was melt kneaded at 190° C. for 3 minutes using a Labo Plastomill, and the melt was cooled to solidify into a compound. The compound had no observable bleeding of amine-based compound (D) under visual inspection. Table 2 shows the results of the evaluations of various properties performed for the compound.

### Example 4

In Example 4, 99.5 parts by mass of the polymer composition obtained in Synthesis Example 1 was dry blended with 0.5 parts by mass of N,N,N′N′-tetramethyl-p-diaminodiphenylmethane used as amine-based compound (D). The mixture was melt kneaded at 190° C. for 3 minutes using a Labo Plastomill, and the melt was cooled to solidify into a compound. The compound had no observable bleeding of amine-based compound (D) under visual inspection. Table 2 shows the results of the evaluations of various properties performed for the compound.

### Example 5

In Example 5, 96.0 parts by mass of the polymer composition obtained in Synthesis Example 1 was dry blended with 4.0 parts by mass of dibutylhydroxytoluene used as phenol-based compound (C). The mixture was melt kneaded at 190° C. for 3 minutes using a Labo Plastomill, and the melt was cooled to solidify into a compound. The compound had no observable bleeding of phenol-based compound (C) under visual inspection. Table 2 shows the results of the evaluations of various properties performed for the compound.

### Example 6

In Example 6, 93.0 parts by mass of the polymer composition obtained in Synthesis Example 1 was dry blended with 7.0 parts by mass of N-phenyl-N′-(1,3-dimethylbutyl)-p-phenylenediamine used as amine-based compound (D). The mixture was melt kneaded at 190° C. for 3 minutes using a Labo Plastomill, and the melt was cooled to solidify into a compound. The compound surface had some bleeding of amine-based compound (D) under visual inspection. Table 2 shows the results of the evaluations of various properties performed for the compound.

### Example 7

In Example 7, 90.0 parts by mass of the polymer composition obtained in Synthesis Example 1 was dry blended with 10.0 parts by mass of 2-[1-(2-hydroxy-3,5-di-t-pentylphenyl)ethyl]-4,6-di-t-pentylphenyl acrylate used as phenol-based compound (C). The mixture was melt kneaded at 190° C. for 3 minutes using a Labo Plastomill, and the melt was cooled to solidify into a compound. The compound had no observable bleeding of phenol-based compound (C) under visual inspection. Table 2 shows the results of the evaluations of various properties performed for the compound.

### Example 8

In Example 8, 99.0 parts by mass of the polymer composition obtained in Synthesis Example 1 was dry blended with 1.0 part by mass of tris(nonylphenyl)phosphite used as phosphorus-based compound (E). The mixture was melt kneaded at 190° C. for 3 minutes using a Labo Plastomill, and the melt was cooled to solidify into a compound. The compound had no observable bleeding of phosphorus-based compound (E) under visual inspection. Table 2 shows the results of the evaluations of various properties performed for the compound.

### Example 9

In Example 9, 99.7 parts by mass of the polymer composition obtained in Synthesis Example 1 was dry blended with 0.2 parts by mass of N-phenyl-N′-(1,3-dimethylbutyl)-p-phenylenediamine used as amine-based compound (D), and 0.1 parts by mass of tris(nonylphenyl)phosphite used as phosphorus-based compound (E). The mixture was melt kneaded at 190° C. for 3 minutes using a Labo Plastomill, and the melt was cooled to solidify into a compound. The compound had no observable bleeding of compounds (D) and (E) under visual inspection. Table 2 shows the results of the evaluations of various properties performed for the compound. In Table 2, the number under the column “Amount added [parts by mass]” represents the total mass of amine-based compound (D) and phosphorus-based compound (E).

### Comparative Example 1

A commercially available ethylene-vinyl alcohol copolymer (E105 manufactured by Kuraray Co., Ltd.) was dry blended with the compound shown in Table 2 as amine-based compound (D). These were blended in the mass ratio shown in Table 2. The mixture was melt kneaded at 190° C. for 3 minutes using a Labo Plastomill, and the melt was cooled to solidify into a compound. Table 2 shows the results of the evaluations of various properties performed for the compound.

### Comparative Example 2

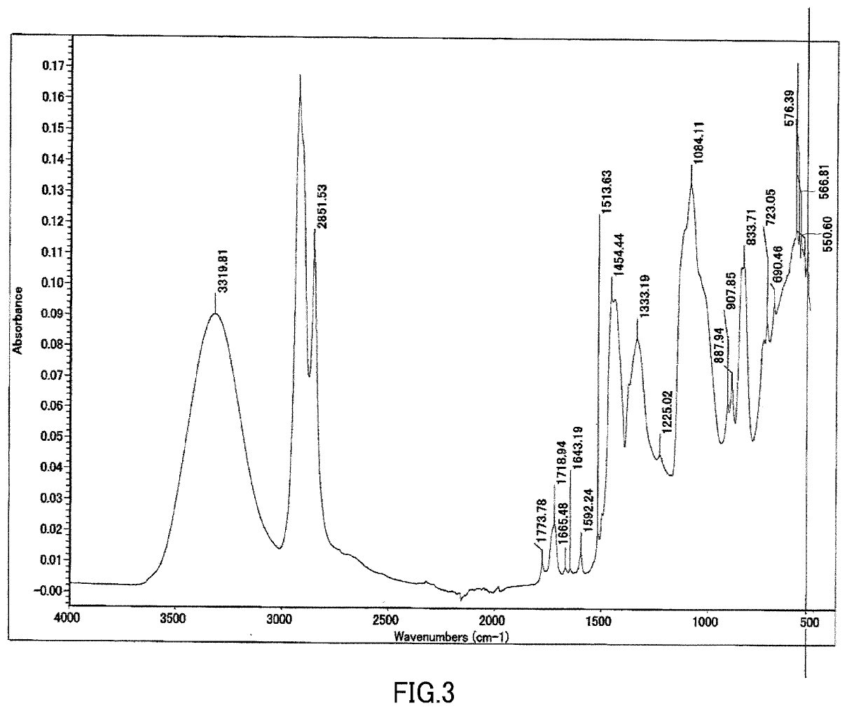

The polymer composition obtained in Synthesis Example 1 was melt kneaded at 190° C. for 3 minutes using a Labo Plastomill, and the melt was cooled to solidify into a compound. The evaluation results are presented in Table 2. FIG. 3 shows the result of the FT-IR analysis conducted for a small piece of specimen taken from a film molded from the compound. As shown in FIG. 3, the FT-IR spectrum had a peak at 1,719 cm⁻¹. It is to be noted here that the compound had serious gel formation, and was not usable for mechanical strength evaluation of a molded film, though a FT-IR analysis was possible using a small piece of specimen.

### Comparative Example 3

In Comparative Example 3, 90.0 parts by mass of the polymer composition obtained in Synthesis Example 1 was dry blended with 10.0 part by mass of 2-mercaptobenzimidazole. The mixture was melt kneaded at 190° C. for 3 minutes using a Labo Plastomill, and the melt was cooled to solidify into a compound. The compound surface had some bleeding of 2-mercaptobenzimidazole under visual inspection. Table 2 shows the results of the evaluations of various properties performed for the compound. It is to be noted here that the compound had serious gel formation, and was not usable for mechanical strength evaluation of a molded film, though a FT-IR analysis was possible using a small piece of specimen.

TABLE 1

| | | Graft copolymer (B1) | | | | Polymer composition | |
|---|---|---|---|---|---|---|---|
| | | | | Content ratio of side chain | Content ratio of vinyl alcohol | obtained in Synthesis | |
| | | | Side-chain | (content ratio with respect | unit (content ratio with respect | Example | |
| | Vinyl alcohol | Main-chain | synthetic | to total mass of main | to total mass of main chain | | Total degree of |
| | polymer (A) | polymer | rubber | chain and side chain) | and side chain) | (A)/(B1) | modification |
| | Polymer species | species | species | [mass %] | [mass %] | mass ratio | [mol %] |
| Synthesis | EVOH | EVOH | Polyisoprene | 67.3 | 25.0 | 59.2/40.8 | 19.7 |
| Example 1 | | | | | | | |
| Synthesis | EVOH | EVOH | Polybutadiene | 53.9 | 30.7 | 22.2/77.8 | 33.1 |
| Example 2 | | | | | | | |

In the Table, EVOH means ethylene-vinyl alcohol copolymer.

TABLE 21

| | Resin composition | | | | | Results of property evaluations | | | |
|---|---|---|---|---|---|---|---|---|---|
| | | | | Phenol-based compound (C), amine-based | | | | Evaluation of | |
| | | | | compound (D), and/or | | | | mechanical | |
| | Polymer composition | | | phosphorus-based compound (E) | | | Presence | strength | |
| | | Vinyl | | | Amount | | or | Tensile | |
| | | alcohol | Graft | | added | Evaluation | absence | elastic | Fracture |
| | | polymer | copolymer | | [parts by | of heat | of | modulus | elongation |
| | Type | (A) | (B1) | Compound names | mass] | stability | bleeding | [kgf/mm²] | [%] |
| Ex. 1 | Synthesis | EVOH | Polyisoprene graft | N-Phenyl-N′-(1,3-dimethylbutyl)- | 0.5 | Satisfactory | Absent | 79 | 34 |
| | Example 1 | | EVOH | p-phenylenediamine | | | | | |
| Ex. 2 | Synthesis | EVOH | Polybutadiene | N-Phenyl-N′-(1,3-dimethylbutyl)- | 1.0 | Satisfactory | Absent | 31 | 29 |
| | Example 2 | | graft EVOH | p-phenylenediamine | | | | | |
| Ex. 3 | Synthesis | EVOH | Polyisoprene graft | 2,3:5,6-Dibenzo-1,4-thiazine | 0.5 | Satisfactory | Absent | 81 | 41 |
| | Example 1 | | EVOH | | | | | | |
| Ex. 4 | Synthesis | EVOH | Polyisoprene graft | N,N,N′N′-Teiramethyl-p- | 0.5 | Satisfactory | Absent | 85 | 39 |
| | Example 1 | | EVOH | diaminodiphenylmethane | | | | | |
| Ex. 5 | Synthesis | EVOH | Polyisoprene graft | Dibutylhydroxytoluene | 4.0 | Satisfactory | Absent | 70 | 31 |
| | Example 1 | | EVOH | | | | | | |
| Ex. 6 | Synthesis | EVOH | Polyisoprene graft | N-Phenyl-N′-(1,3-dimethylbutyl)- | 7.0 | Satisfactory | Present | 69 | 25 |
| | Example 1 | | EVOH | p-phenylenediamine | | | | | |
| Ex. 7 | Synthesis | EVOH | Polyisoprene graft | 2-[1-(2-Hydroxy-3,5-di-t- | 10.0 | Satisfactory | Present | 65 | 23 |
| | Example 1 | | EVOH | pentylphenyl)ethyl]-4,6-di-t- | | | | | |
| | | | | pentylphenyl acrylate | | | | | |
| Ex. 8 | Synthesis | EVOH | Polyisoprene graft | Tris(nonylphenyl)phosphite | 1.0 | Satisfactory | Absent | 80 | 24 |
| | Example 1 | | EVOH | | | | | | |
| Ex. 9 | Synthesis | EVOH | Polyisoprene graft | N-Phenyl-N′-(1,3-dimethylbutyl)- | 0.3 | Satisfactory | Absent | 75 | 30 |
| | Example 1 | | EVOH | p-phenylenediamine, | | | | | |
| | | | | tris(nonylphenyl)phosphite | | | | | |
| Com. | — | EVOH | — | N-Phenyl-N′-(1,3-dimethylbutyl)- | 0.5 | Satisfactory | Absent | 319 | 7 |
| Ex. 1 | | | | p-phenylenediamine | | | | | |
| Com. | Synthesis | EVOH | Polyisoprene graft | — | — | Unsatisfactory | — | — | — |
| Ex. 2 | Example 1 | | EVOH | | | | | | |
| Com. | Synthesis | EVOH | Polyisoprene graft | 2-Mercaptobenzimidazole | 10.0 | Unsatisfactory | Present | — | — |
| Ex. 3 | Example 1 | | EVOH | | | | | | |

As is clear from the Examples above, it can be seen that resin compositions of the present invention exhibit excellent heat stability during molding, despite having higher flexibility than vinyl alcohol polymers. It can also be seen that molded bodies prepared under prolonged high-temperature molding conditions have superior mechanical strength. A resin composition of the present invention should therefore be able to form molded bodies that are more flexible and less likely to crack than traditional vinyl alcohol polymers.

As demonstrated in Comparative Example 1, unmodified vinyl alcohol polymers have high tensile elastic modulus, and are hard and brittle. In the absence of at least one compound selected from the group consisting of a phenol-based compound (C), an amine-based compound (D), and a phosphorus-based compound (E), serious heat deterioration occurs under prolonged high-temperature molding conditions, and molding is not possible, as demonstrated in Comparative Examples 2 and 3.

1. A resin composition comprising:
a copolymer (B) constituted of a vinyl alcohol polymer (B-1) region and a diene polymer (B-2) region; and
at least one compound selected from the group consisting of a phenol-based compound (C), an amine-based compound (D), and a phosphorus-based compound (E).

2. The resin composition according to claim 1, wherein the copolymer (B) is a graft copolymer (B1).

3. The resin composition according to claim 1, wherein the phenol-based compound (C), the amine-based compound (D), or the phosphorus-based compound (E) has a molecular weight of from 100 to 2,000.

4. The resin composition according to claim 1, wherein the resin composition comprises 0.05 to 15 parts by mass of at least one compound selected from the group consisting of the phenol-based compound (C), the amine-based compound (D), and the phosphorus-based compound (E) per 100 parts by mass of the resin composition.

5. The resin composition according to claim 1, wherein the resin composition further comprises a vinyl alcohol polymer (A).

6. The resin composition according to claim 1, wherein the phenol-based compound (C) is a compound represented by the following general formula [I] or [II]; 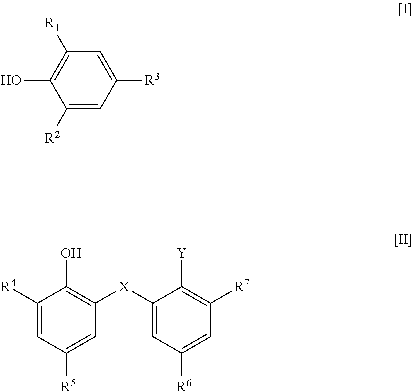
wherein R¹ to R⁷ each independently represent a hydrocarbon group having 1 to 15 carbon atoms, X represents a divalent hydrocarbon group having 1 to 15 carbon atoms, and Y represents a vinyloxy group or a (meth)acryloyloxy group, where the hydrocarbon groups represented by R¹ to R⁷ and X optionally contain at least one kind of group selected from the group consisting of —O—, —S—, —NH—, —N(R⁸)—, —O(CO)—, and —CO—, where R⁸ represents a hydrocarbon group having 1 to 6 carbon atoms.

7. The resin composition according to claim 6, wherein the phenol-based compound (C) is a compound represented by general formula [I], where R¹, R², and R³ are hydrocarbon groups having 1 to 6 carbon atoms.

8. The resin composition according to claim 6, wherein the phenol-based compound (C) is a compound represented by general formula [II], where R⁴, R⁵, R⁶, and R⁷ are hydrocarbon groups having 1 to 6 carbon atoms, X is a divalent hydrocarbon group having 1 to 6 carbon atoms, and Y is an acryloyloxy group.

9. The resin composition according to claim 1, wherein the phenol-based compound (C) is at least one selected from the group consisting of dibutylhydroxytoluene and 2[1-(2-hydroxy-3,5-di-t-pentylphenyl)ethyl]-4,6-di-t-pentylphenyl acrylate.

10. The resin composition according to claim 1, wherein the amine-based compound (D) is an amine having an aromatic group.

11. The resin composition according to claim 10, wherein the amine having an aromatic group is a secondary amine having two or more aromatic rings, or a tertiary amine having two or more aromatic rings.

12. The resin composition according to claim 11, wherein the secondary amine having two or more aromatic rings is a compound represented by the following general formula [IV]: 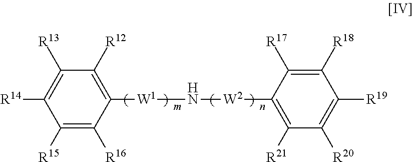
wherein R¹² to R²¹ each independently represent a hydrogen atom or a hydrocarbon group having 1 to 15 carbon atoms, W¹ and W² represent divalent hydrocarbon groups having 1 to 15 carbon atoms, and m and n are each independently 0 or 1, where the hydrocarbon groups represented by R¹² to R²¹ and W¹ and W² optionally contain at least one kind of group selected from the group consisting of —O—, —S—, —NH—, —N(R²²)—, —O(CO)—, and —CO—, and wherein R¹² to R²¹ optionally together form a ring, and R²² represents a hydrocarbon group having 1 to 6 carbon atoms.

13. The resin composition according to claim 11, wherein the secondary amine having two or more aromatic rings is an amine having a diarylamine skeleton.

14. The resin composition according to claim 13, wherein the amine having a diarylamine skeleton is at least one selected from the group consisting of 4,4′-bis(α, α-dimethylbenzyl)diphenylamine, N-phenyl-N′-isopropyl-p-phenylenediamine, N-phenyl-N′-(1,3-dimethylbutyl)-p-phenylenediamine, 2,3:5,6-dibenzo-1,4-thiazine, and N,N,N′N′-tetramethyl-p-diaminodiphenylmethane.

15. The resin composition according to claim 1, wherein the phosphorus-based compound (E) is a trivalent phosphite ester.

16. The resin composition according to claim 1, wherein the resin composition comprises at least one compound selected from the group consisting of the phenol-based compound (C) and the amine-based compound (D); and the phosphorus-based compound (E).

17. The resin composition according to claim 16, wherein the resin composition has a mass ratio (W_{CD}/W_{E}) of 90/10 to 50/50, where W_{CD} is a mass of at least one compound selected from the group consisting of the phenol-based compound (C) and the amine-based compound (D), and W_{E} is a mass of the phosphorus-based compound (E).

18. The resin composition according to claim 16, wherein the resin composition comprises the amine-based compound (D) and the phosphorus-based compound (E).

19. A film comprising the resin composition of claim 1.
